(19) United States
(12) Patent Application Publication
(10) Pub. No.: US 2014/0192845 A1
(43) Pub. Date: Jul. 10, 2014

(54) Method and Apparatus For an Adaptive Multi-Antenna System

(71) Applicant: MOTOROLA MOBILITY LLC, Libertyville, IL (US)

(72) Inventors: Istvan J. Szini, Grayslake, IL (US); Eric L. Krenz, Crystal Lake, IL (US)

(73) Assignee: MOTOROLA MOBILITY LLC, Libertyville, IL (US)

(21) Appl. No.: 13/737,971

(22) Filed: Jan. 10, 2013

(51) Int. Cl. H04B 7/04

(52) U.S. Cl. CPC H04B 7/0413; H04B 7/0417
USPC 375/219; 375/267

(57) ABSTRACT

A method is used for reconfiguring an electronic device, having at least three antenna elements, between different antenna modes. The method includes configuring, by a controller, the electronic device into a first antenna mode, wherein at least two of the antenna elements are coupled together to operate as a single antenna. The method further includes, reconfiguring, by the controller, the electronic device from the first antenna mode into a second antenna mode, wherein at least one antenna configured for use during the second antenna mode includes only a single antenna element.

### FIELD OF THE DISCLOSURE

The present disclosure relates generally to multi-antenna systems and more particularly to adaptively reconfiguring multi-antenna systems.

### BACKGROUND

Next generation wireless systems make use of multiple transmitters and receivers (i.e., multiple or multi-antenna systems) in a mobile device and in a base station. Multi-antenna systems are also known as Multiple Input-Multiple Output (MIMO) systems. The availability of MIMO enables communicating data over multiple paths or streams in the uplink and downlink directions.

In a MIMO system, spatial multiplexing can be used to increase bandwidth for data transmissions by, for example, dividing a high rate data stream into multiple low rate data streams and sending each low rate data stream over the same channel using different antennas. In other words, different data streams are transmitted over the same channel using different antennas. Carrier aggregation (CA) is another technique that uses multiple channels to increase effective bandwidth of wireless communications, wherein multiple (e.g., different) data streams are sent over multiple channels in the same or different bands using the same or different antennas.

In addition, in a MIMO system, spatial diversity can be used to make data transmissions more robust or reliable. More specifically, using spatial diversity, robustness or reliability is increased by creating multiple data streams of the same data and transmitting the same data redundantly over the same channel using multiple antennas.

With the increasing implementation of multi-antenna systems and techniques that utilize the multi-antenna systems, there is a need for an adaptive multi-antenna system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram illustrating one example of a next generation wireless network in which embodiments of the present teaching operate.

FIG. 2 is a block diagram illustrating one example of a MIMO 2×2 antenna topology in accordance with the present teachings.

FIG. 3 is a block diagram illustrating one example of a MIMO 4×4 antenna topology in accordance with the present teachings.

FIG. 4 is a block diagram illustrating one example of a MIMO 3×3 antenna topology in accordance with the present teachings.

FIG. 5 is a block diagram illustrating one example of an antenna topology that supports MIMO 2×2 with carrier aggregation in accordance with the present teachings.

FIG. 6 is a flow chart illustrating one example of a method for configuring a wireless device in accordance with the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, the present disclosure provides a method and apparatus for adaptively reconfiguring an antenna system into one of a MIMO mode or a carrier aggregation mode. In one example, the antenna system is reconfigured into one of a MIMO 2×2, 3×3, 4×4, N×N or N×M mode, or a 2×2 carrier aggregation mode. When configured into one antenna mode, one or more antenna elements are coupled together to operate as a single antenna, such as in a MIMO 2×2 mode. When configured into at least one other antenna mode, multiple antenna elements are operated or driven individually as separate antennas, such as in a MIMO 3×3 or 4×4 mode or in a MIMO 2×2 with carrier aggregation mode. The present teachings, thereby, enable multiple antenna elements to be adaptively configured or, in other words, configured “on the fly” between multiple antenna modes to communicate (i.e., transmit and/or receive) multiple data streams over one or more channels in a way that maximizes transmission and reception capability while, for instance, minimizing the area on a device needed to support the antenna architecture. This leads to higher data rates and more reliable and robust data transmissions.

For example, in accordance with an embodiment of the teachings herein is a method for reconfiguring an electronic device, having at least three antenna elements, between different antenna modes. The method comprises: configuring, by a controller, the electronic device into a first antenna mode, wherein at least two of the antenna elements are coupled together to operate as a single antenna; and reconfiguring, by the controller, the electronic device from the first antenna mode into a second antenna mode, wherein at least one antenna configured for use during the second antenna mode includes only a single antenna element.

In accordance with another embodiment of the teaching herein is an electronic device that includes at least three antenna elements and a controller. The controller is operative to: configure the antenna elements into a first antenna configuration comprising at least two of the antenna elements coupled together to operate as a single antenna; and reconfigure the antenna elements into a second antenna configuration, wherein at least one antenna in the second antenna configuration includes only a single antenna element, which is configured to individually operate as a separate antenna.

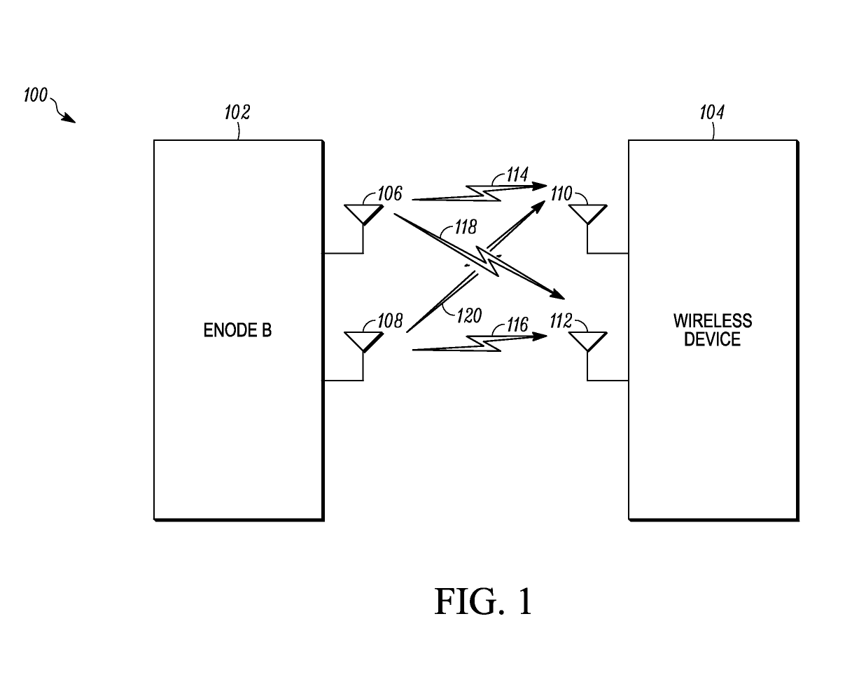

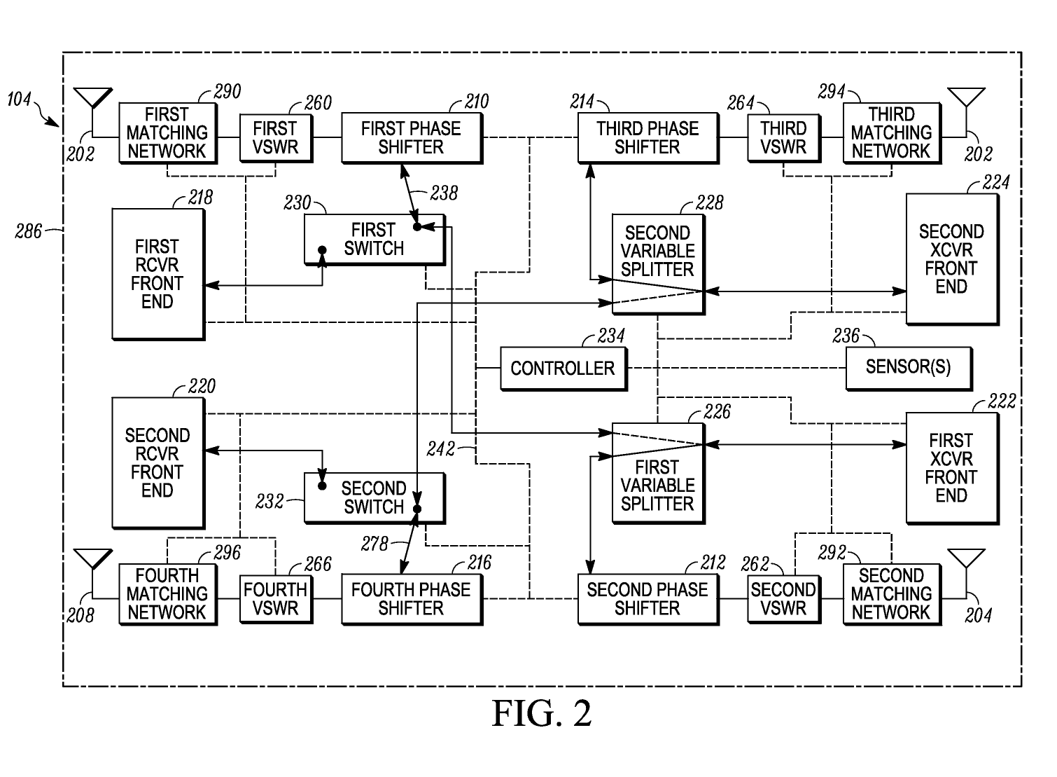

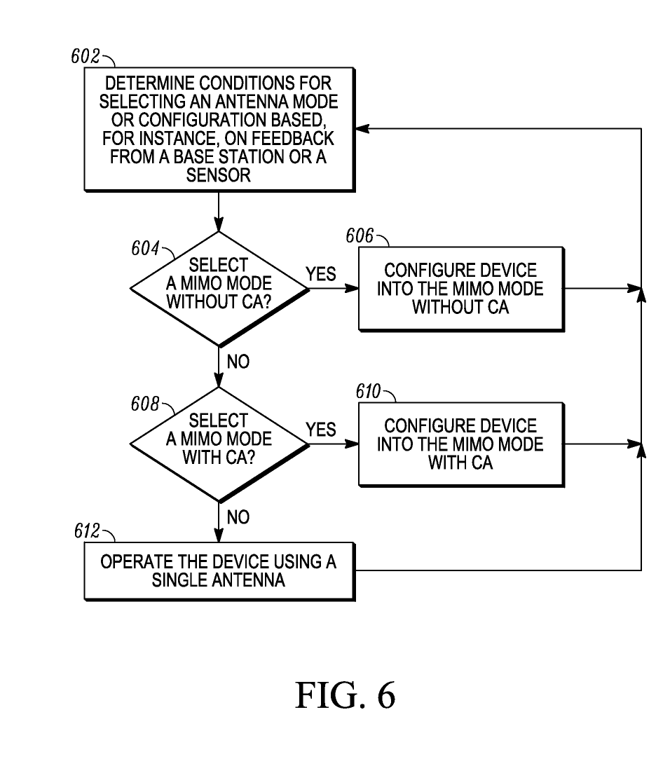

Referring now to the drawings and in particular to FIG. 1, a next generation multiple antenna network or system 100 is shown. The network 100 is adapted in accordance with the present teachings as described herein. In an embodiment, network 100 is a 3rd Generation Partnership Project (3GPP) network, such as a Long Term Evolution (LTE) network 100, meaning that network infrastructure equipment, e.g., 102, and wireless devices, e.g., 104 (both referred to herein generally as electronic devices or devices), operating within the system 100 operate in conformance with at least portions of one or more standards documents developed by 3GPP, such as one or more LTE standards documents developed by 3GPP. In general, as used herein, devices such as 102 and 104, being “configured,” “operative” or “adapted” means that such devices are implemented using one or more hardware devices such as memory devices, network interfaces such as transceivers, and/or processors that are operatively coupled, for example, as is shown in FIGS. 2-5. The memory devices, network interfaces, and/or processors, when programmed (e.g., using software or firmware), form the means for these system elements to implement their desired functionality, for example, as illustrated by reference to the methods shown in FIG. 6. Although the system 100 is described as a 3GPP LTE system, the present teachings can be incorporated into other types of multiple antenna systems such as WiMax systems, Evolved High Speed Packet Access (HSPA+) systems, Wireless Local Area Network (WLAN) 802.11n systems, etc.

The system 100 network infrastructure equipment includes an Evolved Packet Core (EPC), which functions as the network core. The EPC is coupled to an Evolved Universal Terrestrial Radio Access Network (E-UTRAN), which serves as the access network for the one or more wireless devices 104 that communicate using the system 100. The E-UTRAN includes one or more eNodeBs (eNBs) 102, which are the LTE equivalent of base stations. At least one eNB 102 includes multiple antenna elements, e.g., 106 and 108, operatively coupled to multiple transmitters and/or multiple receivers. As used herein, an antenna element is a radiating component within an electronic device, such as electronic device 102 or 104, which is used to send or receive, over the air, a radio wave containing a data stream. In accordance with the present teachings, multiple (e.g., two) radiating elements can operate collectively as a single antenna that is coupled to a single transmitter and/or receiver for enabling data communications; or any one or more of the radiating elements can operate individually as an antenna that is coupled to a single transmitter and/or receiver for enabling data communications. Accordingly, an antenna is defined as comprising one or more antenna elements coupled to a single transmitter, a single receiver, or a single transceiver during the communication by the antenna of a data stream.

In example implementations, the wireless device 104 comprises a User Equipment (UE) such as a radio telephone, a smart phone, a tablet computer, a personal digital assistant, a gaming console, a remote controller, an electronic book reader, or any other type of electronic device capable of interconnecting with a telecommunications network via the eNB 102. The wireless device 104 is used to establish connections with the eNB 102 to communicate data. Data, as used herein, means any type of information that can be transferred or communicated between two or more devices operating in a communication system, such as the system 100. Accordingly, data includes information such as, by way of example, voice data, control data, video data, etc. In this illustrated embodiment, the wireless device 104 includes multiple antenna elements, e.g., 110 and 112, dynamically coupled to multiple transmitters and/or multiple receivers.

A signal is defined as a waveform (such as a radio wave) that carries a data stream. A data stream (also referred to herein as a stream or a stream of data) is defined as a sequence of digitally encoded data units (such as data packets containing data), which is used to transmit or receive information. A channel (also referred to herein as a carrier and a component carrier) is defined as the logical representation of radio frequency (RF) resources carrying data streams; and the channel is characterized by a transmit or receive frequency (within a given frequency band) and a capacity, such as bandwidth in Hz or data rate in bits per second. A frequency band is defined as a range of frequencies (e.g., 700-800 MHz) from which channels are selected and allocated to electronic devices for data communications.

In the uplink direction (i.e., from a wireless device to the network infrastructure), for example, antenna element 110 transmits data comprising a stream carried by the signal 114, which is intended for at least one of the antenna elements such as antenna element 106; and antenna element 112 transmits data comprising a stream carried by the signal 116, which is intended for at least one of the antenna elements such as antenna element 108. In this example, the wireless device 104 transmits data streams to the eNB 102, but in actual systems, the eNB 102 also transmits data streams in the downlink direction to the wireless device 104. In that alternative example, the antenna element 106 transmits a data stream intended for antenna element 110, and the antenna element 108 transmits a data stream intended for antenna element 112. Moreover, the streams transported by the signals 114, 116 are shown as being transmitted directly from antenna elements 110, 112 to antenna elements 106, 108. However, in at least some scenarios, when transmissions occur in the uplink or downlink direction, the receiving antennas also receive indirect components 118, 120 of the transmitted streams due, for instance, to reflections, interference, and/or varying propagation paths. Thus, in this particular example, in the uplink direction, each of the antenna elements 106, 108 might receive signals emanating from both antenna elements 110, 112. The eNB 102 would then be configured to reconstruct the transmitted data from the multiple received direct and indirect stream components.

FIGS. 2-5 illustrate various embodiments of the present teachings. More particularly, a multiple antenna structure for an electronic device, such as a wireless device 104, is shown having different antenna configurations (also referred to herein as antenna modes) in the FIGS. 2-5. Although the wireless device 104 is described, the antenna structure shown in FIGS. 2-5 is applicable to an infrastructure device such as the eNB 102. Moreover, the wireless device 104 components are the same throughout the various FIGS. 2-5 and will, therefore, only be described in detail with respect to FIG. 2. However, switch components are reconfigured between the FIGS. 2-5 to illustrate the different antenna modes in which the wireless device 104 (or eNB 102) is configurable in accordance with the present teachings.

In general, the electronic device illustrated in FIG. 2-5 comprises: at least three antenna elements (in this case four antenna elements, but there could be additional antenna elements in another embodiment); and a controller operative to: configure the antenna elements into a first antenna configuration comprising at least two of the antenna elements coupled together to operate as a single antenna; and reconfigure the antenna elements into a second antenna configuration, wherein at least one (i.e., one or more) antenna in the second antenna configuration includes only a single antenna element, which is configured to individually operate as a separate antenna. In one example implementation of the second antenna configuration, each antenna element operates individually as a separate antenna. In another example implementation of the second antenna configuration at least two antenna elements are coupled together to operate as a single antenna, and the remaining antenna elements operate individually as separate antennas.

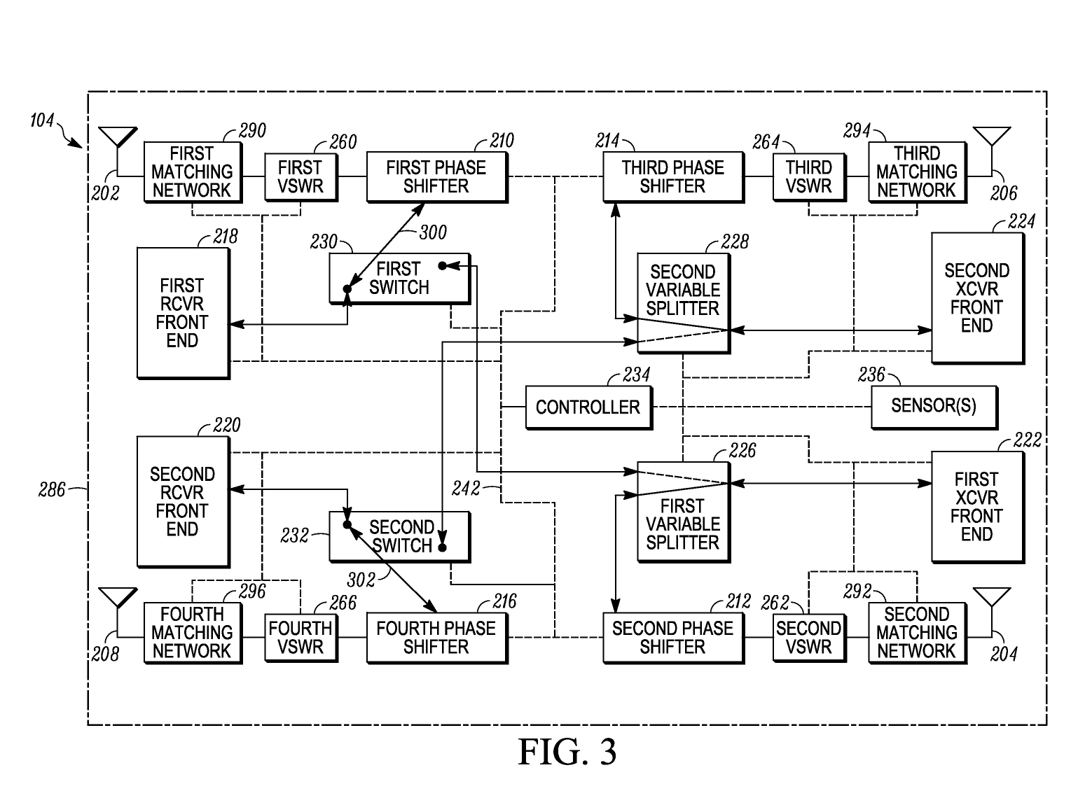

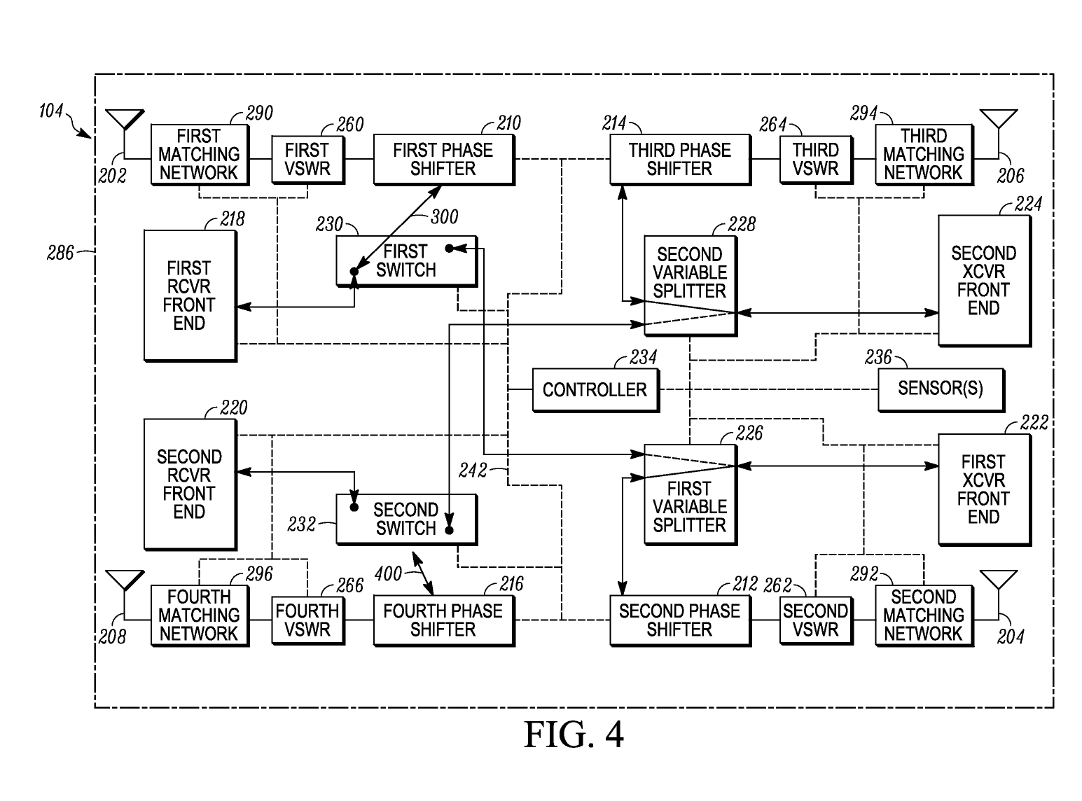

In one embodiment, the first antenna configuration supports communication of a first plurality of data streams using a same first carrier within a first carrier frequency band, and the second antenna configuration supports communication of a second plurality of data streams using a same second carrier within a second carrier frequency band. The first carrier can be the same or different than the second carrier. For example, the first antenna configuration supports multiple-input multiple-output (MIMO) 2×2 communications (as illustrated by reference to FIG. 2), and the second antenna configuration supports MIMO 4×4 communications (as illustrated by reference to FIG. 3) or MIMO 3×3 communications (as illustrated by reference to FIG. 4).

In another embodiment, the second antenna configuration supports communication of a plurality of data streams using a plurality of component carriers from the same or from multiple frequency bands. This embodiment supports carrier aggregation, wherein a plurality of component carriers comprise the plurality of channels used to send or receive different data streams using multiple antennas. In yet another embodiment, the wireless device 104 further comprises a set of switches coupled to the controller and to the at least three antenna elements to configure the antenna elements into the first antenna configuration and to reconfigure the antenna elements into the second antenna configuration, or in other words to configure the antenna elements between a plurality of different antenna modes, such as a plurality of different MIMO modes to support MIMO communications.

In yet another embodiment, the communication device 104 is adaptively configured to support a particular MIMO or MIMO with carrier aggregation mode in response to sense signals (discussed below) and/or eNB 102 messages so that the communication device 104 efficiently and robustly communicates messages with the eNB 102. In one example, adaptively configuring the wireless device 104 includes coupling and/or decoupling one or more of the antenna elements 202, 204, 206, 208, to operate individually or with another antenna element to support a particular MIMO or MIMO with carrier aggregation mode.

As used herein, MIMO communications are wireless transmissions or receptions over the same channel using multiple antennas. For example, MIMO 2×2 communications use two transmitting antennas (that transmit two data streams) and two receiving antennas (that receive the two transmitted data streams); and MIMO 3×3 communications use three transmitting antennas (that transmit three data streams) and three receiving antennas (that receive the three transmitted data streams), etc. MIMO N×N communications use N transmitting antennas (that transmit N data streams) and N receiving antennas (that receive the N transmitted data streams). Also, MIMO N×M communications, where N is not equal to M, use N transmitting antennas (that transmit M or fewer data streams) and M receiving antennas (that receive the M or fewer transmitted data streams). Moreover, an antenna mode or configuration is defined as a current configuration from multiple possible configurations of antenna elements of a device to enable data communications. A MIMO mode is defined as an antenna mode or configuration that supports the transmission or reception of multiple data streams over one or more channels using multiple antennas. A carrier aggregation mode is a MIMO mode that supports the transmission or reception of multiple data streams over multiple channels and/or frequency bands using multiple antennas.

Although the embodiments depicted in FIG. 2-5 show a topology using four antenna elements configured to operate in a MIMO 2×2, 3×3, 4×4 mode, and a MIMO 2×2 with carrier aggregation mode, in other embodiments, an electronic device, such as wireless device 104 is configured with more than four antennas. For example, the wireless device 104 may comprise a smart phone, laptop, tablet, or some other type of wireless device large enough to accommodate more than four antennas and more than four transceiver/receiver front ends. When more than four antenna elements are disposed on or in the wireless device 104, the antenna topology of the wireless device 104 is able to support higher orders of MIMO communications.

Turning now to FIG. 2, which shows a block diagram illustrating an embodiment of a wireless device 104 having an antenna topology configured into a first antenna mode in accordance with the teachings herein. The antenna mode shown in FIG. 2 comprises a MIMO mode and more particularly a MIMO 2×2 mode. However, the “first” antenna mode can be any one of a plurality of possible antenna modes for the wireless device 104, including one or more of the antenna modes shown in FIGS. 3-5.

The illustrated antenna topology of FIG. 2 includes a first antenna element 202, a second antenna element 204, a third antenna element 206, a fourth antenna element 208, a first phase shifter 210, a second phase shifter 212, a third phase shifter 214, a fourth phase shifter 216, a first receiver front end 218, a second receiver front end 220, a first transceiver front end 222, a second transceiver front end 224, a first variable splitter 226, a second variable splitter 228, first switch 230 and second switch 232 (which comprise a set of switches), a first voltage standing wave ratio (VSWR) detector 260, a second VSWR detector 262, a third VSWR detector 264, a fourth VSWR detector 266, a first matching network 290, a second matching network 292, a third matching network 294, a fourth matching network 296, a controller 234 and at least one sensor 236. Following is a brief description of the components of wireless device 104, their connectivity and their functionality.

In an embodiment, the at least three (in this case four) antenna elements comprises a first antenna element 202 disposed near a first corner of a planar rectangular ground plane 286 of the electronic device 104, a second antenna element 204 disposed near a second corner of the planar rectangular ground plane 286 and diagonal to the first antenna element 202, a third antenna element 206 disposed near a third corner of the planar rectangular ground plane 286 adjacent to the first and second corners, and a fourth antenna element 208 disposed near a fourth corner of the planar rectangular ground plane 286 adjacent to the first and second corners and diagonal to the third antenna element 206. The first antenna element 202, the second antenna element 204, the third antenna element 206, and the fourth antenna element 108 can be the same type of antenna element or a combination of different types of antenna elements. In one example implementation, the types of antenna elements are one or more of the following: L-shaped, inverted F-shaped antenna (IFA), planar inverted F-shaped antenna (PIFA), monopole, folded inverted conformal antenna (FICA), or patch, for example. The type of antenna elements used can depend on a number of factors including, but not limited to, the operational frequencies of the electronic device, its size and shape, and the various antenna system performance targets. Moreover, antenna elements may be positioned differently within the wireless device 104 depending, for instance, on the size and shape of the device. Also, in some implementations, one or more antenna elements may partially or fully overlap with the ground plane 286.

As shown, the first adjustable phase shifter 210 is coupled to the first antenna element 202 and is coupled to the controller 234 and to the first VSWR 260. The second adjustable phase shifter 212 is coupled to the second antenna element 204 and is coupled to the controller 234 and to the second VSWR 262. The third adjustable phase shifter 214 is coupled to the third antenna element 206 and is coupled to the controller 234 and to the third VSWR 264; and the fourth adjustable phase shifter 216 is coupled to the fourth antenna element 208 and is coupled to the controller 234 and to the fourth VSWR 266. As shown, the controller 234 is coupled to the phase shifters 210-216, the matching networks 290-296, and the VSWRs 260-266. The controller is configured to provide control signals to the phase shifters 210-216 and the matching networks 290-296 to, in one embodiment, adjust the parameters of these components to effectively operate in different frequency bands. Furthermore, the controller is configured to receive input or readings from the VSWRs 260-266 to control one or more other components in the wireless device 104 such as the matching networks 290-296, by way of example.

In one embodiment, the controller 234 is a baseband processor. In another embodiment, the functionality of the controller 234 is implemented on an integrated circuit separate from a baseband processor. For example, as a baseband processor, the controller 234 is comprised one or more integrated circuit chips having data processing hardware, a memory (e.g., random access memory (RAM)) and firmware or software used to configure, e.g., program, the baseband processor to perform a number of radio control functions that require an antenna element for data communications. The functions include, but are not limited to: encoding and decoding digital data; generating or parsing out certain control, controlling matching network and phase shift components, sensor reading, VSWR measurement analysis; etc.

Accordingly, in one embodiment, matching networks 290-296 are adjustable matching networks (and tuners) configured to provide an input impedance to the antenna elements 202-208, respectively, in response to control signals communicated from the controller 234. More particularly, each matching network matches the load impedance of the antenna element, to which it is connected, to the impedance of a transmitter and/or receiver. This is done to maximize power transfer and minimize reflections from the antenna element over a broad range of frequencies including, in one example implementation, multiple frequency bands. In another embodiment, each adjustable matching network is operable in response to feedback from the set of (i.e., one or more) sensors 236 on the wireless device 104, which are used to determine a manner of use of the electronic device. For example, but not by way of limitation, the manner of operating an electronic device includes: in proximity to the head (i.e., head), from the head to the hand and vice versa (i.e., head+hand), with two hands, with a car kit, with a lapdoc, etc. Example sensor implementations are described below in additional detail.

Each first phase shifter 210-216, in one example implementation, provides a controllable phase shift of a radio frequency (RF) signal (modulated with a bit stream) that is to be radiated by an antenna coupled to the phase shifter. In one embodiment, the phase shift provided by each phase shifter 210-216 is controlled by control signals from the controller 234 and depends, at least partially, on the particular antenna mode or configuration and the frequency band of operation. For example, in an implementation where two diagonally-positioned antenna elements are coupled together to form a single antenna, the phase shifters coupled to the two antenna elements may be controlled to drive the RF signals to the two antenna elements out-of-phase during low-band transmissions. During high band transmissions, the phase shifters coupled to the two diagonally-positioned and coupled antenna elements may be controlled to drive the RF signals to the two antenna elements either out-of-phase or in-phase.

The VSWR detectors 260-266, in one example implementation, are each configured to monitor forward and reflected RF power of first antenna element 202 transmissions on a transmission line between a transmitter and/or receiver and an antenna in order to calculate VSWR measurements. The VSWR measurements indicate the degree of mismatch between the transmitter and/or receiver and the antenna. The VSWR detectors 260-266 communicate the VSWR measurements to the controller 234 for use, in one embodiment, as tuning parameters to correct the mismatch, for example, using the phase shifters 210-216.

Continuing the description of the components of the electronic device 104, the first receiver front end 218 is coupled to the controller 234 and to the first switch 230, wherein the first switch 230 is also coupled to the first variable splitter 226 and the controller 234. The first transceiver front end 222 is coupled to the controller 234 and the first variable splitter 226, wherein the first variable splitter 226 is also coupled to the second adjustable phase shifter 212 and the controller 234. The second receiver front end 220 is coupled to the controller 234 and to the second switch 232, wherein the second switch 232 is also coupled to the second variable splitter 228 and the controller 234. The second transceiver front end 224 is coupled to the controller 234 and the second variable splitter 228, wherein the second variable splitter 228 is also coupled to the third adjustable phase shifter 214 and the controller 234.

In one example implementation, the first and second transceiver front ends 222, 224 and the first and second receiver front ends 218, 220 each include a high/low diplexer (not shown), high and low band selectors (not/shown), and a plurality of duplexers (now shown) each operative over a different frequency band. By way of an illustrative LTE implementation, the plurality of duplexers comprises six duplexers operative over frequency bands B1, B2, B3 (high bands over which the high band selector is also operative) and bands B5, B8, B13 (low bands over which the low band selector is also operative). However, any suitable combination of frequency bands can be used depending, for instance, on the wireless access technology used. Moreover, the first and second transceiver front ends 222, 224 each further include a plurality of transmitters and receivers each operative over different frequency bands. Whereas, the first and second receiver front ends 218, 220 each further include only the plurality receivers each operative over different frequency bands. Alternatively, all of the front ends could be transceiver front ends to provide further flexibility in the antenna configurations and antenna modes of operation available to the electronic device.

During a transmit operation, where the controller 234 is a baseband processor, the controller 234 receives data, for instance, audio (e.g., voice) data from a microphone, video data from a recording device, or other data from an application in the electronic device 104. The controller 234 supplies a digital information signal containing the data (also referred herein as a data stream) to one or more of the transmitters within transceivers 222, 222. Accordingly, the processing device selects the one or more transmitters, duplexers, and high or low band selectors based on the frequency band within which the channel(s) fall, which is used to transmit the data stream). Each transmitter modulates the data stream onto a carrier signal, and the antenna radiates the modulated data stream.

The one or more sensors 236 may be disposed within or on a housing of the wireless device 104. In one example implementation, at least some of sensors 236 are adapted, during operation, to detect the proximity of the wireless device 104 to external objects, such as parts of a user's body or other objects. Sensors 236 include, for example but not by way of limitation, one or more capacitive sensors, infrared (IR) proximity sensors, pressure sensors, or other types of sensors. A capacitive sensor may be activated when a nominally conductive material (e.g., a user's hand or cheek) contacts or is sufficiently close to the sensor. An IR proximity sensor may be activated when it is in proximity with any material that scatters IR energy. The one or more sensors 236 may be positioned, for example, on the front, back, and/or sides of the phone housing. According to another embodiment, sensors 236 include one or more accelerometers, which enable a determination of whether the wireless device 104 is being used in a portrait or landscape mode, for example. In one embodiment, the sensors 236 provide sense signals to the controller 234 that indicate whether an antenna is impaired, which in one example indicates a user's hand is covering the antenna. The controller 234, in one embodiment, as explained below by reference to FIG. 6, reconfigures the wireless device 104 in response to the sense signals and/or in response to commands from the eNB 102.

As mentioned above, the controller 234 controls the position of the first switch 230 and the second switch 232 to configure the antenna mode for the wireless device 104. In the particular implementation scenario illustrated in FIG. 2, the first switch 230 is configured (to a position 238) to connect the first adjustable phase shifter (210) to the first variable splitter (226) in order to couple the first and second antenna elements 202, 204 together to operate as a first antenna; and the second switch (232) is configured (to a position 278) to connect the fourth adjustable phase shifter 216 to the second variable splitter 228 in order to couple the third and fourth antenna elements 206, 208 together to operate as a second antenna.

With the first switch 230 in the position 238, the first antenna element 202 is coupled to the first transceiver front end 222, which is also coupled to the second antenna element 204. Moreover, the controller configures the first variable splitter 226 so that signals from both the first antenna element 202 and the second antenna element 204 are propagated to and/or from the first transceiver front end 222. When configured in this manner, the first antenna element 202 and the second antenna element 204 operate pair-wise as a single antenna. This single antenna, in one embodiment, operates as the first antenna in the MIMO 2×2 mode. Similarly, with the second switch 232 in the position 278, the fourth antenna element 208 is coupled to the second transceiver front end 224, which is also coupled to the third antenna element 206. Moreover, the controller configures the second variable splitter 228 so that signals from both the third antenna element 206 and the fourth antenna element 208 are propagated to and/or from the second transceiver front end 224. When configured in this manner, the third antenna element 206 and the fourth antenna element 208 operate pair-wise as a single antenna. This single antenna, in one embodiment, operates as the second antenna in the MIMO 2×2 mode. In the topology illustrated in the FIG. 2, MIMO 2×2 is achieved by combining the excitation of all four antenna elements 202, 204, 206 and 208. More particularly, variable splitters 226 and 228, respectively, split the front end 222 and 224 signals. Accordingly, the first front end 222 drives both antennas 202 and 204 with variable magnitude and phase, and the second front end 224 drives the antennas 206 and 208 with variable magnitude and phase.

The resulting antenna configuration shown in FIG. 2 is, accordingly, a MIMO 2×2 mode that supports MIMO 2×2 communications. In one embodiment, the MIMO 2×2 mode supports spatial diversity. This includes transmit diversity where both antennas are used to redundantly transmit the same data stream over the same channel and receive diversity where both antennas are used to receive a data stream redundantly transmitted over the same channel. In another embodiment, the MIMO 2×2 mode supports spatial multiplexing where two different streams are transmitted or received over the same channel using the two pair-wise antennas. In one embodiment, in response to sense signals and commands from the eNB 102, the controller 234 reconfigures and drives the first and second antennas to perform spatial multiplexing or spatial diversity.

As stated above, as shown in FIG. 2, the wireless device 104 is configured, by the controller 234, into a first antenna mode, wherein at least two of the antenna elements are coupled together to operate as a single antenna. More particularly, the controller 234 configures first switch 230 to couple the first and second antenna elements 202, 204 together to operate pair-wise as a single antenna; and the controller 234 configures second switch 232 to couple the third and fourth antenna elements 206, 208 together to operate pair-wise as a single antenna. FIGS. 3-5, in contrast, illustrate embodiments, of where the controller 234 configures or reconfigures the wireless device into a second antenna mode, wherein at least one antenna configured for use during the second antenna mode includes only a single antenna element. More particularly, in the second antenna configuration shown in FIGS. 3-5, the first switch 230 is configured to disconnect the first adjustable phase shifter from the first variable splitter in order to decouple the first and second antenna elements, and the second switch is configured to disconnect the fourth adjustable phase shifter from the second variable splitter in order to decouple the third and fourth antenna elements.

Turing first to FIG. 3, an antenna topology configured to support MIMO 4×4 communications is shown, in accordance with the present teachings. In the embodiment depicted in FIG. 3, the first switch 230 is configured (to a position 300) to couple the first antenna element 202 to the first receiver front end 218 using first matching network 290, the first phase shifter 210, and the first switch 230. In this configuration, the antenna element 202 operates individually (i.e., on its own) as a first antenna. The second antenna element 204 is coupled to the first transceiver front end 222 using the first variable splitter 226, such that the antenna element 204 operates individually as a second antenna. In this case, the first variable splitter 226 is configured such that all of the signal communicated from the first transceiver front end 222 is routed to the second antenna 204. The third antenna element 206 is coupled to the second transceiver front end 224 using the second variable splitter 228, such that the antenna element 206 operates individually as a third antenna. In this case, the second variable splitter 228 is configured such that all of the signal communicated from the second transceiver front end 224 is routed to the third antenna 206. The second switch 232 is configured (to a position 302) to couple the fourth antenna element 208 to the second receiver front end 220 using the fourth matching network 296, the fourth phase shifter 216, and the second switch 232. In this configuration, the antenna element 208 operates individually as a fourth antenna. This MIMO 4×4 mode can be used to support spatial diversity and/or spatial multiplexing for one to four data streams using, in one embodiment, the same channel.

FIG. 4 shows an antenna topology configured to support MIMO 3×3 communications, in accordance with an embodiment. The configuration shown in FIG. 4 is similar to the configuration depicted in FIG. 3 except that the second switch 232 is configured such that the fourth antenna element 208 is not connected to the receiver front end 220. Thus, the fourth antenna element 208 does not operate as an antenna in this configuration. This MIMO 3×3 mode can be used to support spatial diversity and/or spatial multiplexing for one to three data streams using, in one embodiment, the same channel.

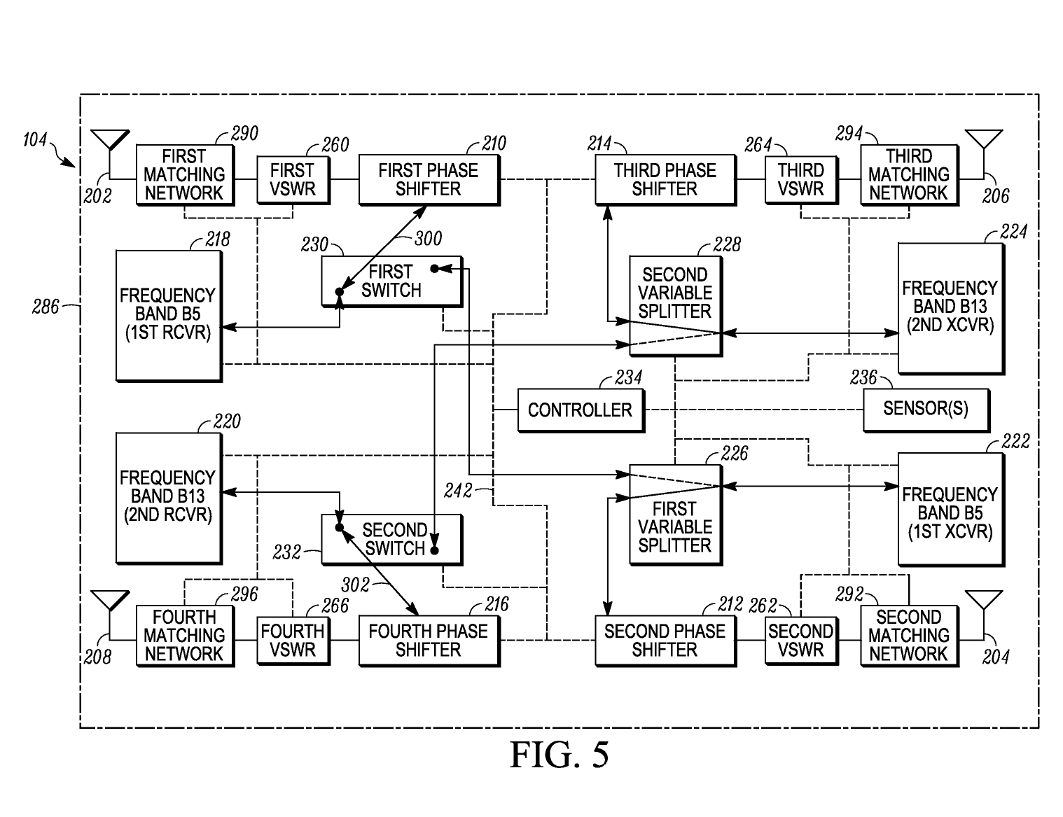

FIG. 5 shows an antenna topology configured to support carrier aggregation, in accordance with an embodiment. The configuration of FIG. 5 supports communication of a plurality of data streams using component carriers from the same or from multiple frequency bands. The switch configuration shown in FIG. 5 is the same as the switch configuration depicted in FIG. 3. However, the transceivers 224 and 222 are shown as operating in different frequency bands (e.g., bands B13 and B5), thereby indicating that the transmission and/or reception channels were allocated from different frequency bands. Similarly, the receivers 218 and 220 are shown as operating in different frequency bands (e.g., bands B13 and B5), thereby indicating that the reception channels were allocated from different frequency bands. This carrier aggregation mode can be used to support spatial diversity and/or spatial multiplexing for two to four data streams using different channels that may be in the same or different frequency bands.

In an alternate carrier aggregation configuration (not shown), the switch configuration is the same as the switch configuration depicted in FIG. 2. Thus, when configured in this manner, the third antenna element 206 and the fourth antenna element 208 operate pair-wise as a single antenna; and the first antenna element 202 and the second antenna element 204 operate pair-wise as a single antenna. This antenna topology enables 2×2 carrier aggregation in the same or different frequency bands.

Turning now to FIG. 6, a logical flow chart is shown illustrating a method 600 for determining an antenna mode in which to configure an electronic device for communicating data, in accordance with an embodiment. In an embodiment, the controller 234 performs the method 600 to reconfigure an electronic device such as the wireless device 104 (as described) or the eNB 102 into the different antenna modes or configurations.

Turning now to the details of method 600. At 602, the controller 234 determines conditions for selecting an antenna mode for wireless communications. In one embodiment, the antenna mode is determined based on at least one of (i.e., one or both of): feedback from a base station (such as the eNB 102) or feedback from a sensor on the wireless device 104. This enables the controller 234 to adaptively configure the antenna elements in response to, for instance, the environment around the electronic device or network conditions within which the device communicates.

For example, the controller 234 configures or reconfigures the antenna topology of the wireless device 104 in accordance with measurements or signals (the feedback) communicated from the sensors 236 and/or one or more of the VSWR detectors 260, 262, 264, 266. In the process of monitoring sensor 236 measurements, the controller 234, in one example, determines the position of the wireless device 104 with respect to a user, or in other words determines a manner or use or a use case for the wireless device 104, and responsively determines a suitable antenna configuration. For example, the use case scenario may be head, head-to-hand, two hands, car kit, lapdoc, etc. In one illustrative implementation, the controller 234 determines that the wireless device is near the user's head (i.e., head position) and responsively selects the antenna configuration that enables better system efficiency depending, for instance, on the user case, e.g., head, head+hand, different hand grips, etc. In one example, the low frequency band antennas are positioned at the bottom of the wireless device 104, and the high band antennas are positioned at the top of the wireless device 104 (or vice-versa) depending on the user case.

In another example implementation, the eNB 102 communicates messages (the feedback) to the controller 234 of the wireless device 104, which includes network information about ongoing communications between the wireless device 104 and the eNB 102. During these communications, in one example, the eNB 102 and the wireless device 104 exchange network messages concerning the MIMO and carrier aggregation capabilities of the wireless device 104 and the eNB 102. In accordance with this network messaging, the eNB 102 instructs the wireless device 104 to reconfigure itself based on, for example, network configuration parameters, signal strength measurements, or channel requirements.

Using the information determined at 602, the controller determines in accordance with sense signals and/or commands from the eNB 102, at 604 and 608, respectively, whether to select a MIMO mode without carrier aggregation or with carrier aggregation. If the MIMO mode without carrier aggregation is selected, the controller 234 configures or reconfigures the electronic device into this mode at 606. If the MIMO mode with carrier aggregation is selected, the controller 234 configures or reconfigures the electronic device into this mode at 610. If neither MIMO mode is selected at 608 or 608, the wireless device 104 operates using a single antenna at 612.

For example, at one point in time at 606, the controller 234 configures the wireless device 104 into a first antenna mode, wherein at least two of the antenna elements (such as, antenna element 202, 204, 206 and 208) are coupled together to operate as a single antenna. At another point in time, at 608 the controller 234 reconfigures the wireless device 104 from the first antenna mode into a second antenna mode, wherein at least one antenna configured for use during the second mode comprises a single antenna element. In one example, the first antenna mode comprises a first MIMO mode, and the second antenna mode comprises a second MIMO mode. Where the first MIMO mode comprises a MIMO N×N mode and the second MIMO mode comprises an MIMO M×M mode, where N=2 and M=3 or 4. In this example implementation, the first antenna mode is used for communicating a first plurality data streams using a same first channel, and the second antenna mode is used for communicating a second plurality data streams using a same second channel. The first and second channels can be the same or different channels.

In another embodiment, the first antenna mode comprises a MIMO mode and the second antenna mode comprises a MIMO mode with carrier aggregation. In this example implementation, the first antenna mode is used for communicating a first plurality data streams using a same first channel, and the second antenna mode is used for communicating a second plurality data streams using a plurality of different channels. In one embodiment, at least two channels of the plurality of different channels are from different frequency bands. Alternatively, all of the channels of the plurality of different channels are from the same frequency band.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for reconfiguring an electronic device, having at least three antenna elements, between different antenna modes, the method comprising:
configuring, by a controller, the electronic device into a first antenna mode, wherein at least two of the antenna elements are coupled together to operate as a single antenna; and
reconfiguring, by the controller, the electronic device from the first antenna mode into a second antenna mode, wherein at least one antenna configured for use during the second antenna mode includes only a single antenna element.

2. The method of claim 1, wherein the first antenna mode comprises a first multiple-input and multiple-output (MIMO) mode, and the second antenna mode comprises a second MIMO mode.

3. The method of claim 2, wherein the first MIMO mode comprises a MIMO N×N mode and the second MIMO mode comprises an MIMO M×M mode.

4. The method of claim 3, wherein N=2 and M=3 or 4.

5. The method of claim 1, wherein the first antenna mode comprises a multiple-input and multiple-output (MIMO) mode, and the second antenna mode comprises a MIMO mode with carrier aggregation.

6. The method of claim 1, wherein the second antenna mode is determined based on at least one of: feedback from a base station or feedback from a sensor on the electronic device.

7. The method of claim 1, wherein the first antenna mode is used for communicating a first plurality data streams using a same first channel, and the second antenna mode is used for communicating a second plurality data streams using a same second channel.

8. The method of claim 1, wherein the first antenna mode is used for communicating a first plurality data streams using a same first channel, and the second antenna mode is used for communicating a second plurality data streams using a plurality of different channels.

9. The method of claim 8, wherein at least two channels of the plurality of different channels are from different frequency bands.

10. The method of claim 8, wherein all of the channels of the plurality of different channels are from the same frequency band.

11. An electronic device comprising:
at least three antenna elements; and
a controller operative to:
configure the antenna elements into a first antenna configuration comprising at least two of the antenna elements coupled together to operate as a single antenna; and
reconfigure the antenna elements into a second antenna configuration, wherein at least one antenna in the second antenna configuration includes only a single antenna element, which is configured to individually operate as a separate antenna.

12. The electronic device of claim 11, wherein the second antenna configuration supports communication of a plurality of data streams using a plurality of component carriers from the same or from multiple frequency bands.

13. The electronic device of claim 11, wherein the first antenna configuration supports communication of a first plurality of data streams using a same first carrier within a first carrier frequency band, and the second antenna configuration supports communication of a second plurality of data streams using a same second carrier within a second carrier frequency band.

14. The electronic device of claim 13, wherein the first antenna configuration supports multiple-input multiple-output (MIMO) 2×2 communications, and the second antenna configuration supports MIMO 4×4 communications or MIMO 3×3 communications.

15. The electronic device of claim 11 further comprising an adjustable matching network coupled to each antenna element and to the controller, wherein each adjustable matching network is operable in response to feedback from a set of sensors on the electronic device, which are used to determine a manner of use of the electronic device.

16. The electronic device of claim 11 further comprising a set of switches coupled to the controller and to the at least three antenna elements to configure the antenna elements into the first antenna configuration and to reconfigure the antenna elements into the second antenna configuration.

17. The electronic device of claim 16, wherein:
the at least three antenna elements comprises a first antenna element disposed near a first corner of a planar rectangular ground plane of the electronic device, a second antenna element disposed near a second corner of the planar rectangular ground plane and diagonal to the first antenna element, a third antenna element disposed near a third corner of the planar rectangular ground plane adjacent to the first and second corners, and a fourth antenna element disposed near a fourth corner of the planar rectangular ground plane adjacent to the first and second corners and diagonal to the third antenna element; and
the first antenna element, the second antenna element, the third antenna element, and the fourth antenna element are the same type of antenna element or a combination of different types of antenna elements.

18. The electronic device of claim 17 further comprising:
a first adjustable phase shifter coupled to the first antenna element and to the controller;
a second adjustable phase shifter coupled to the second antenna element and to the controller;
a third adjustable phase shifter coupled to the third antenna element and to the controller; and
a fourth adjustable phase shifter coupled to the fourth antenna element and to the controller.

19. The electronic device of claim 18 further comprising:
first and second variable splitters;
first and second switches of the set of switches;
a first receiver front end coupled to the controller and to the first switch, which is also coupled to the first variable splitter and the controller;
a first transceiver front end coupled to the controller and the first variable splitter, which is also coupled to the second adjustable phase shifter and the controller;
a second receiver front end coupled to the controller and to the second switch, which is also coupled to the second variable splitter and the controller;
a second transceiver front end coupled to the controller and the second variable splitter, which is also coupled to the third adjustable phase shifter and the controller.

20. The electronic device of claim 19, wherein:
in the first antenna configuration, the first switch is configured to connect the first adjustable phase shifter to the first variable splitter in order to couple the first and second antenna elements together to operate as a first antenna, and the second switch is configured to connect the fourth adjustable phase shifter to the second variable splitter in order to couple the third and fourth antenna elements together to operate as a second antenna;
in the second antenna configuration, the first switch is configured to disconnect the first adjustable phase shifter from the first variable splitter in order to decouple the first and second antenna elements, and the second switch is configured to disconnect the fourth adjustable phase shifter from the second variable splitter in order to decouple the third and fourth antenna elements.
